(19) United States
(12) Patent Application Publication
(10) Pub. No.: US 2007/0263918 A1
(43) Pub. Date: Nov. 15, 2007

(54) METHOD AND SYSTEM OF RECOGNIZING PROFILES AND DEFECTS IN WOOD PROCESSING

(76) Inventor: David Jenya, Vancouver (CA)

Correspondence Address: FASKEN MARTINEAU DUMOULIN, LLP, 2100 - 1075 WEST GEORGIA STREET, VANCOUVER, BC, V6E-3G2, CA

(21) Appl. No.: 11/674,605

(22) Filed: Feb. 13, 2007

Related U.S. Application Data
(60) Provisional application No. 60/772,550, filed on Feb. 13, 2006.

(51) Int. Cl. G06K 9/00

(52) U.S. Cl. 382/141

(57) ABSTRACT

A method of measuring a profile of lumber, is provided, in which a set of scan data from a piece of lumber is obtained using laser scanners, the data obtained is categorized into x and V coordinate Fields as used to determine flaws in the lumber. The data is used to categorize groups of data points (using their slopes) into the categories falling vertical, failing wane strong, falling wane weak, horizontal, rising wane weak, rising wane strong, rising vertical or space, based on the value of the slope and predetermined thresholds.

This application claims the benefit of U.S. Provisional Patent Application No. 60/772,550 filed Feb. 12, 2006.

### FIELD OF INVENTION

This invention relates to processes and controls in the wood industry and more particularly to using machine vision in such processes and controls.

### BACKGROUND

Sawmills are used to convert logs to boards (also known as lumber). This conversion process uses a system of conveyors and saws to cut the logs into the desired shapes. Unfortunately, lumber and other wood products exhibit width and thickness variations both along the length of each board (known as “within” board) and from one piece of board to another (known as “between” board). However, for a piece of lumber or board to be acceptable, the dimension of these variations must fall within customer specified tolerance limits. To provide a useful product, sawmills and secondary manufacturing plants typically check the quality of the boards, including their sizes, before sending it to the customer. Though effective, this approach is often too late and is inefficient. Alternatively, the quality of boards can be determined as they leave the sawmill, however it is difficult to determine if every board coming out of a particular machine, such as a board edger or resaw, is within the required limits as the board leaves the sawmill, to prevent such machine from making more defective products. Furthermore, in sawmills, a thin piece of lumber at a wet-mill can cause the planer to skip, and an overly thick piece of lumber can cause jamming and machining problems, as well as reducing the volume and value recoverable from each log, resulting in increased cost and time lost in determining and repairing these problems.

Sawmills are divided into a plurality of “processes” or “machine centers”, in which a single machine, such a saw, carries out on operation on lumber or a log. One of the difficulties in measuring the variations in lumber ties in the nature of wood, as wood is a biological non-homogeneous material that may not respond uniformly to the same sawing conditions. This inevitably gives rise to “within” and “between” board variations. However, the major cause of unacceptable sawing variations is machinery malfunction. These malfunctions may include, but are not limited to: poor saw tension, dull saws, bad saw-teeth, worn-out bearings, improper set-works; and feed speed, rotational speed, and saw alignment problems. To detect these malfunctions, most sawmills have adopted hand-held-caliper assisted Statistical Process Control (“SPC”) Programs.

SPC programs focus on continuous improvement through constant applications of statistical methods to detect assignable causes and recommend correction procedures. The objective of an SPC program is to detect problems as soon as they occur, investigate the problem, and provide solutions as soon as possible. Historically, caliper assisted SPC programs have been used. These caliper assisted SPC programs require the manual collection of measurements and subsequent downloading or manual-data entry into a spreadsheet or database program for statistical analysis. Standard deviations and averages are calculated and compared against expected targets. The sawmill process is deemed under control if the averages are close to a target and within preset upper and lower control limits. The process also provides graphical display functions in the form of control charts showing the target size, lower control limits (LCL) and upper control limits (UCL), and at times, warning limits. Typically, the warning limits are set at two (2) standard deviations on either side of the average, thus ensuring that 95% of the product is conforming; and the LCL and UCL are set at three (3) standard deviations, thus ensuring that 99.97% of the product is within these control limits. A lumber package is generally considered to be acceptable if 95% of the product meets the required specifications for the size and grade label unless a supplier contract specifically states otherwise. Typically, if the number of defective wood products exceeds the 5% limit the customer can claim a refund against the supplier.

Although random sampling-based SPC pro-rams are better than no quality control program at all, they are often too labor intensive, time consuming and, at times, dangerous to implement under saw-mill conditions. Thus, sawmills typically over-size, to ensure a comfortable allowance for undetected large deviations, shrinkage and planning allowances. This results in under-utilization of the increasingly scarce natural resources (the trees) and hence a greater than necessary rate of forest cover removal. In economic terms, the over-sizing reduces sawmill recovery resulting in higher raw-material costs.

Furthermore, the non-continuity of measurements in the SPC program may mean that a sawmill process can operate under “out-of control conditions” for a long period before being detected. This results in wasted production time, wasted raw material and further equipment deterioration, hence higher repair cost and downtime. Also, some machinery problems can cause human injury or death-a cost that is difficult to measure in monetary terms.

Several attempts have been made to introduce machine vision assisted real-time lumber size control methods. These methods have been reasonably successful on single board applications, such as determining the length, thickness and width measurements of a board at the trimmer and planer. Although these methods provide board-to-board measurement, they do not determine problems as they occur, or determine which machine center, let alone the exact saw, is responsible for the defective product. These methods essentially take the difference between two points as the measurement, and such simplicity is inadequate for multi-piece lumber.

In 2000, T. B. Brown, in “Performance Excellence in the Wood Products Industry, Part 2: Size Analysis Considerations” (http://www.fpmti.com/Publications/EM%208731.pdf), reported that there were two technological reasons that automated size control methods had not been successful. One reason was that lasers and other non-contact measuring methods could not measure lumber to a 0.005 to 0.010 inch precision in the mill (the precision necessary to equal dial caliper measurements). The other reason was that the then current systems could not identify the machine center that produced a particular board.

In 2003, a machine vision technology was introduced that claimed to be able to measure the widths of a cant's lumber leaving a curve gang at 300 fpm to within ±0.010″ or better. Although, this technology may achieve acceptable accuracy for the widths of boards, it is important to note that the claim is specific to “width” and not thickness. The algorithms for width measurements are relatively simple as they entail subtracting the maximum from the minimum x or y coordinate values. Such technology may measure thickness to the same degree of accuracy on well-spaced cants. However, what is needed is a process that can be applied to all applications and measurements under difficult conditions, especially wane, sawdust, flare, board movement, step, bark, vibrations and mechanical damage.

In 2004, a prior art real time multi-piece profile processing control system was introduced. Unfortunately, this system is only successful in measuring board thickness on squared cants with well-spaced inner-boards. A fundamental problem with the system was that the algorithms employed were fairly simple and failed to detect edges on rounded profiles precisely. The system was also unable to filter out dust vibrations, flare, misalignment and other sources of distortion resulting in the provision of erroneous reports. Furthermore, the system is unable to be universally applicable to other mill requirements such as face scanning, step recognition and defect recognition.

There are several factors adding to the cost of lumber production. These factors include over sizing (due to failures in real time process control); sawing variations (due to log size, log species, knot class, machinery variations, saw type and saw condition); drying distortions (due to log species, warping and kiln conditions such as temperature, humidity and pressure); shrinkage allowance (due to log species, initial and final moisture content, and dimensions of the log); planar allowance (due to species, the planar, set works, the knife used, and feed speed); and final size (due to log species, initial and final moisture content and dimensions).

### SUMMARY

The method and system according to the invention provides solutions for the problems discussed above and can achieve an accuracy of ±0.002 inches or (±0.006 inches at 6 sigma methodology).

A method for recognizing edges and measuring sizes to under 0.010 inches on complex multi-piece wood profiles is provided herein. The method processes real time laser scans data to give instant sawing quality feedback by measuring lumber thickness and width along the length of the board as the board leaves a machine.

A method of measuring a profile of lumber is provided, including obtaining a set of scan data from a piece of lumber; categorizing said data into specified x and v coordinate fields; for each x and y value, subtracting the preceding x or y value from the succeeding x or y value to determine a slope, and classifying each of said slopes as one of falling vertical, falling wane strong, falling wane weak, horizontal, rising wane weak, rising wane strong, rising vertical or space based on the value of said slope, and predetermined thresholds. The method may group said x and y values into a plurality of groups and may determine if each of said x and y values is a falling or rising edge. The data points can be used to correct or adjust the performance of a machine center.

A system for analyzing lumber at a saw mill is provided, including a machine center for processing a log; a conveyor for moving said log through said machine centre; a nylon strap adjacent to said machine center, said nylon strap removing debris from said lumber leaving said machine center; an air knife positioned adjacent to said machine center, said air knife removing further debris from said lumber leaving said machine center; and a laser scanner taking measurements of said lumber leaving said machine center, after said debris has been removed by said nylon straps and said air knife

### DESCRIPTION OF DRAWINGS

FIG. 1 is a block diagram showing the system according to the invention;

FIG. 2 shows an overview of the lumber moving through the system;

FIG. 3 is a front view of a scanner according to the invention;

FIG. 4 is an alternate side view thereof, showing the lumber passing through a canter;

FIG. 5 above is a top view of the system according to the invention installed on a canter feed;

FIG. 6 s a side view thereof;

FIG. 7 is a flow chart showing the process according to the invention; and

FIG. 8 shows examples of the system analyzing edges.

### DETAILED DESCRIPTION

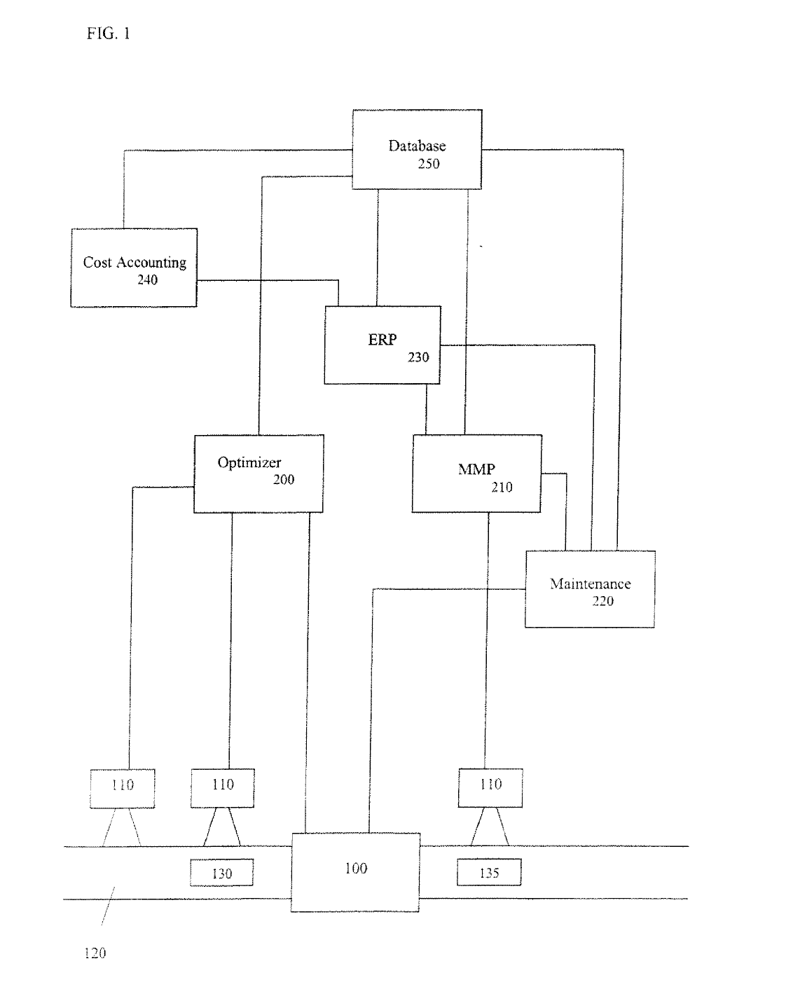

FIG. 1 displays the overview of an implementation of a system according to the invention. Mill components of the system include saw 100 (a gang saw as shown in FIG. 1, although other saws or mill components may he used), laser scanners 110, and conveyor 120, on which logs 130 and later lumber 135 moves. Software components of the system include: optimizer 200; multi-piece profile processor (MPP) 210; maintenance program 220; enterprise resource planning (ERP) system 230; cost accounting program 240; and database 250. These software components may be operated on a single computer or several networked computers. The term “saw” as used in this document means not only traditional machine operated saws found in saw mills, but also canters, board edger, resaw, multirip, gang saw, circular saws, trimmer or other saws and machine centers

In use, laser scanners 110 scan log 130 or lumber 135, and transmit the data obtained thereby to optimizer 210. As used in this document the term “laser scanner” refers to a one or more laser sensors positioned to determine a three dimensional view of the object being scanned. Optimizer 210 processes the data and transmits instructions to saw 100 to optimize the sawing process. The optimizer instructs, through a programmable logic control system (PLC), the positions for the chain, top head, side heads and saw positions given the log or lumber geometry and the optimal cutting pattern decision. Size control scanners 140 take multi-piece profiles of lumber 135 and transmit the data to MPP 210 to conduct saw accuracy analysis. MPP 210 analyzes the average sizes and standard deviations of the lumber passing through saw 100, and reports the saw-specific data to maintenance program 220. Maintenance program 220 corrects any problems as determined using the saw-specific data by sending instructions to saw 100.

MPP 210 also reports saw 100 performance to ERP system 230, including information about average sizes and standard deviations. Optimizer 200, in turn, sends information about log 130 to ERP system 230, such as log dimensions, intended lumber size and recovery per log. Maintenance program 220 sends information about downtime, problem types, and attendant solutions and costs to ERP system 230. Cost accounting program 240) sends operational cost and inventory data to ERP system 230.

ERP system 230, in turn, sends real time optimal parameters to optimizer 200; optimal maintenance instructions to maintenance program 220 (for optimal scheduled preventative maintenance); and real time cost and production data to cost accounting program 240 (for optimal cost accounting and pricing verification).

The processed data created and used by the various software components is stored and shared through database 250 (in a preferred embodiment, database 250 is stored within an integrated data server). Using the closed loop, the system can autocorrect and autosignal major problems to a human interface. An alarm dispatch system (not shown) will alert millwrights instantly to problems beyond the scope of the software components to correct. A paging system may be used to assist in communication with millwrights.

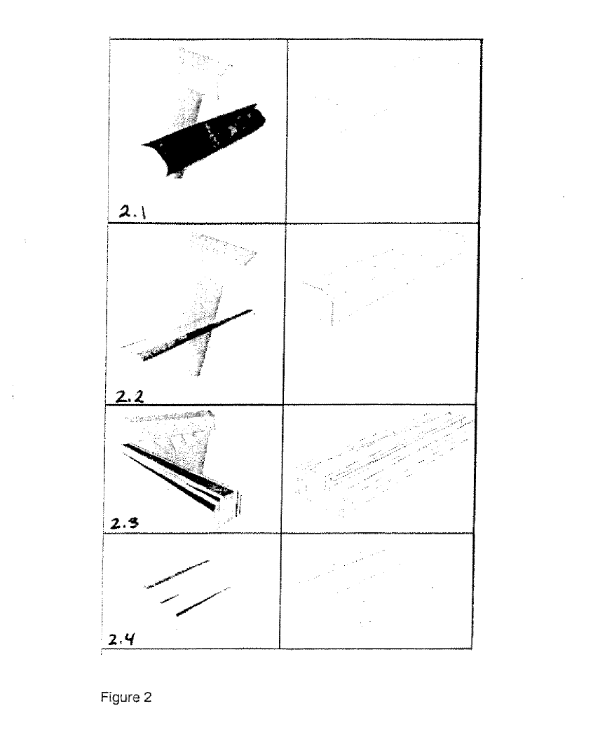

Examples of the scanning process for both logs 130 and lumber 135 are shown in FIG. 2. FIG. 2.1 shows the laser scanner 110 scanning a log 130, and the image produced thereby. This information is sent to optimizer 200, which uses the real time log geometry scan data to maximize recovery of lumber as provided by the instructions from ERP system 230. FIG. 2.2 shows the laser scanner 110 scanning a semi-manufactured cant to confirm sizes and optimality. The data from this scan may be sent to optimizer 100 and MPP 210.

FIG. 2.3 shows the laser scanner 110 scanning lumber 135 to optimize the size thereof. MPP 210 thereby measures board thickness and width alone the length of the log and reports any variation. FIG. 2.4 shows laser scanner 110 scanning lumber 135 to determine saw performance using the saw line. Any variations are reported to MPP 210 and are used to correct saw 100.

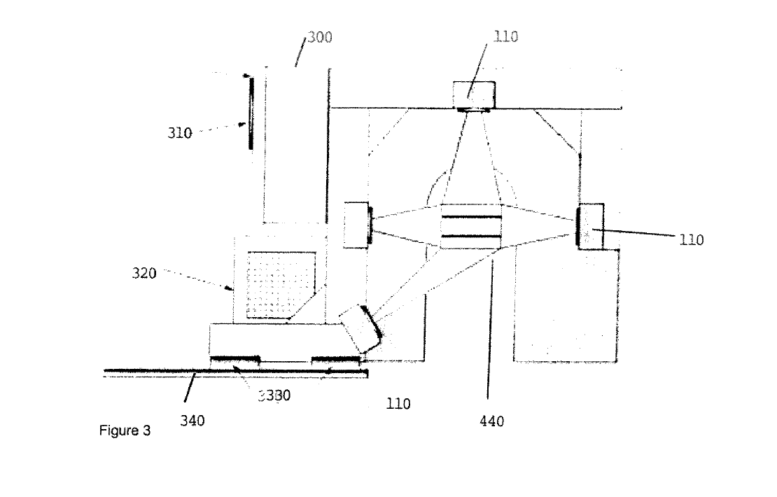

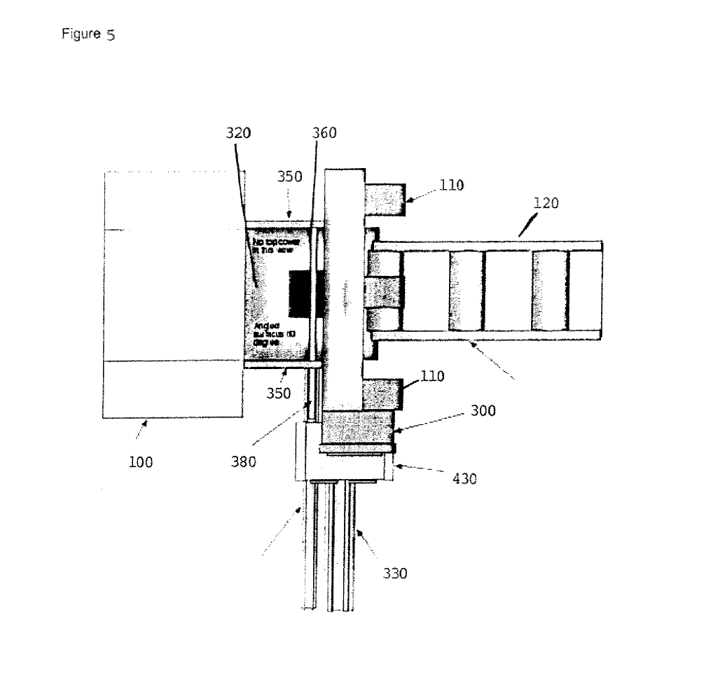

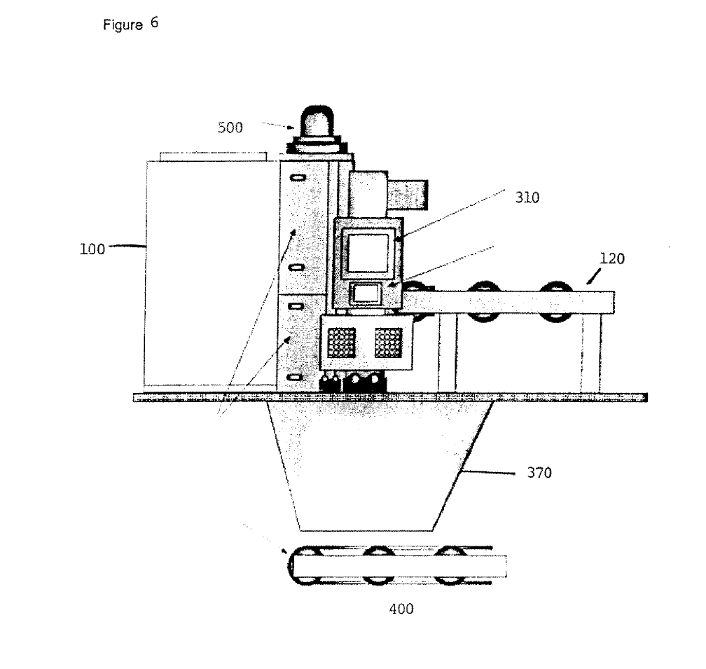

FIGS. 3 through 6 show a laser scanner 80 with several laser scanner heads 110 according to the invention. FIG. 3 above shows computer cabinet 300 with screen 310, smoke cater 320 to absorb dust from the wood cutting machine center, for example a canter or gang saw, and rail system 340 for sliding the scanner head and bearings. The scanner offers a reliable, all-weather, self-cleaning machine vision and intelligence system in a dusty sawmill environment. This configuration is not susceptible to wood debris obstruction, as nylon straps 350 and air knife 355 remove loose wood and dust, so that the scan data from laser scanners 110 is more reliable. Furthermore, the laser scanner head 110 configuration provides 360-degree vision with better resolution. Alternatively, less scanner heads (as few as a single scanner head) can be used to provide 360-degree vision of the lumber or log.

Computer cabinet 300 holds the hardware and software necessary for operation of the laser scanner 100 and for outputting the results of the scans. Screen 310, which may be a TFT screen, is used for displays of output and manual control of laser scanner 110, and allows users to see the inside of saw 100 and scanning area. Smoke or dust eater 320 minimizes image disruption due to smoke (or dust) from jammed sideboards and sawdust in the canter and filters air. Bearing wheels 330 on rail system 340 allow laser scanner 110 to be positioned at various locations along conveyer 120.

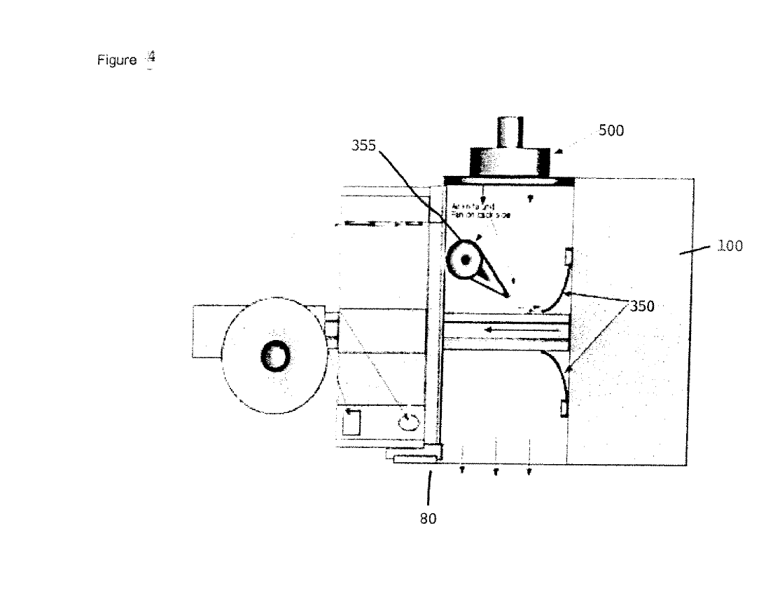

Propeller fan 500 positioned between saw 100 and laser scanner 110 provides a vertical downstream flow of air. Nylon raps 350 brushes off the chips and wood debris from the lumber or log as shown in FIG. 4.

Walls 350 guide wood debris into opening 360, with angled surface 370 leading to opening 360 (preferably angled at approximately 60 degrees). Walls 350 are preferably mounted on hinges (not shown) for easy removal during maintenance. Protection wall 380 is mounted on the floor and allows wood debris to fall to band conveyor 400 for collection. Rails 330 allow protection wall 380 and laser scanner sensor 100 to be moved, respectively. Air filter 430 offers an automated inline wood cleaning procedure wherein debris is extracted from the environment according to size, i.e., large, medium and fine.

As lumber 135 moves through the scan zone 440, images are taken at a rate determined by the laser scanner head 100 camera shutter frequencies. The profile density is determined by the both the feed speed of the conveyor and camera frequency. Higher shutter frequencies are required for high-speed operations.

As lumber 135 stack exits the canter 100, it enters scanning zone 400, and passes through nylon raps 350 and air knife 355 for clearing the log of debris before measurements are taken in the sensor zone.

The Control Algorithm

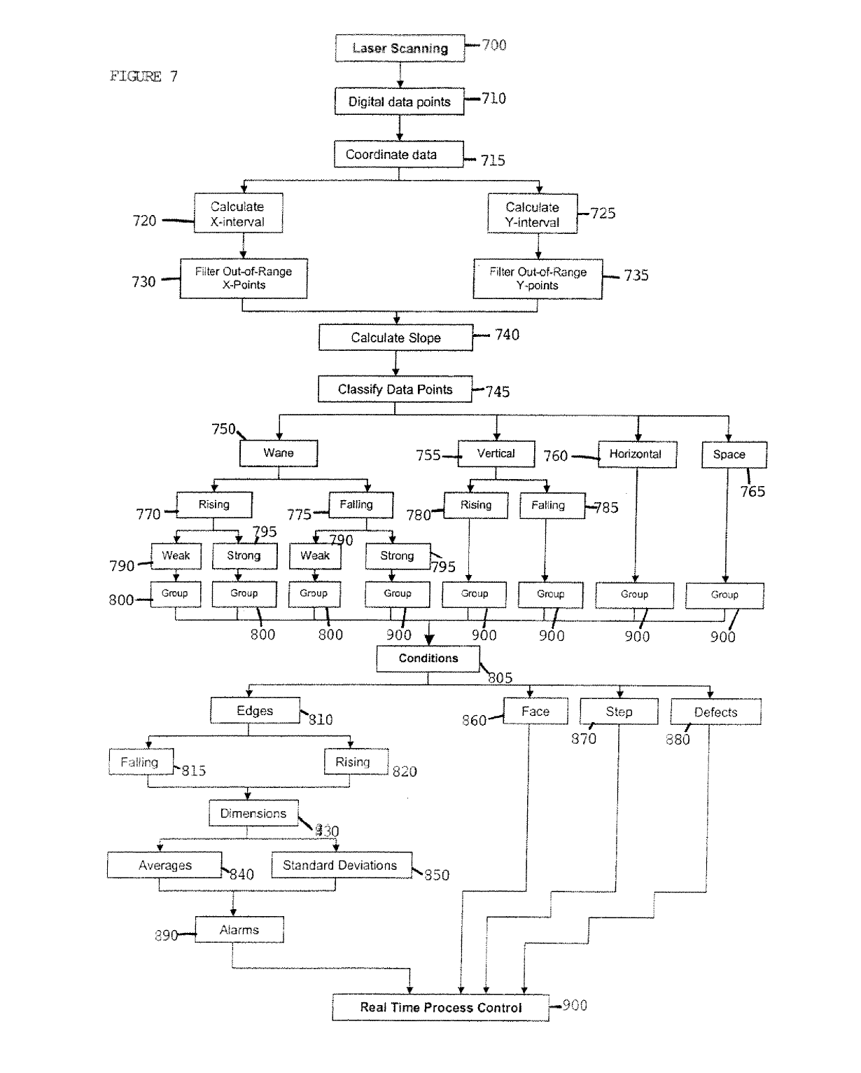

FIG. 7 shows a flow chart showing the process by which information is received from the laser scanners and used to provide real time process control.

The process begins with acquiring input from the laser scanners 110 (step 700). The laser cameras should be positioned to provide a sufficient view of the log or lumber profiles. The cameras transmit the digital data points (step 710) obtained in the scan to a computer. This data is coordinated by being recorded into fields (step 715), showing the camera number, the data point number and the data point's corresponding X and Y coordinates.

The system then runs a pass through all the points received and calculates the point-to-point intervals on both the X and Y axis (step 720 and 725, respectively). These intervals are retained in fields (Xᵢ₊₁−Xᵢ, Yⱼ₊₁−Yⱼ), corresponding to each data point (X, Y).

The data points are then filtered (steps 730 and 735 for the X and Y data points, respectively) based on group, slope and location of each point as a function of tie camera resolution. For example, if the camera resolution is 40 dots per inch (dpi), a separation of more than 0.025 inches prompts the system to search for a recognizable profile within the proximity of that data point. The formula used for this calculation is IF (Xᵢ₊₁-Xᵢ)>1/(camera dpi), “space”. If there are more than one such “spaces” within a specified group threshold, the point is rejected. If the profile is determined to be wane, horizontal or vertical the data point may be retained, otherwise the data point is removed from further processing as the system assumes it is sawdust, a flare or another form of noise.

The slope is then calculated (step 740) based on those data points that pass the first filter. The slope is retained as the tangent (tan θ) or as the angle (θ) in degrees using the formula tan θ=(Yⱼ₊₁−Yⱼ)/(Xᵢ₊₁−Xᵢ).

The resultant angles are then classified into a category (step 745). In an embodiment of the invention, the categories include Wane (step 750). Vertical (step 755). Horizontal (step 760) or Space (step 770). Wane and Vertical angles are subclassified as either Rising (step 770 or 780, respectively) or Falling (step 775 or 785 respectively). The Rising and Falling Wan angles are further subclassified as either Weak: (step 790) or Strong (step 795).

Therefore, in the above embodiment, the categories include: Vertical falling (Vf); Wane Falling Strong (Wfs); Wane Falling Weak (Wfw); Horizontal; Wane Rising Weak (Wrw); Wane Rising Strong (Wrs); and Vertical Rising (Vr), based on predetermined thresholds. Space between boards is also recognized and classified as Space (S). Therefore, every point passing the filter is classified as Vf, Wf, Wf, H, Wrw, Wr, Vr or S. This point classification, taken in groups (step 800), is then used to recognize edges.

Falling Edges

The system then recognizes falling edges (step 810) under different conditions (step 805). There are at least nineteen different conditions that denote a falling edge (step 815), each of which is implemented as an (if, then) test. The tests are numbered as they appear in the sample pseudo code below (i.e. test 7.1 is step 7.1 in the pseudo code). The tests are based on a point I (also referred to herein as i), and points with which I is grouped, expressed as I+x, or I−x. The notation is used to simplify the algorithms and to provide programming notes where I-I denotes a point one point from the current point and 1+6→15 denotes all points that are 6 points from the current point tip to 15 points from the current point.

First in test 7.1, the system retains a V_{f} on Xₘₐₓ. Note that while this appears to be relatively simple, accuracy depends on the ability to filter dust and flare at the ends of the lumber or log's data points.

TEST 7.1: IF(I=Xₘₐₓ, “V_{f}”)

$$\begin{matrix}If X = {X}_{maximum} for all camera data , point is falling edge , “ Vf ” \\ I = current {X}_{max - all cameras}\end{matrix} \qquad ( 7.1 )$$

In test 7.2, a falling edge is recognized when there are at least three consecutive data points characterized as V_{f}. In essence, the systems looks back to the classification, and retains V_{f}s when the points are clearly on a falling edge.

TEST 7.2:

$$If there are 3 consecutive “ Vf ” points ( group ) in step six , “ Vf ” \\ \begin{matrix} & • I & & & = Current Vf & & & & & \\ & • I + 1 -> 3 & & & = Vf & & & & & \\ & • I + 4 & & & = S , Vr & & & & & \end{matrix} \qquad ( 7.2 )$$

In the third test, (Test 7.3), a “V_{f}” is retained, if there is one “V_{f}” substantiated by one “S” in the next five data points. Here, the system searches both backwards and forward to confirm a true falling edge and thus avoids claiming a false edge on the basis of only one “V_{f}”, or failing to detect an edge due to the absence of clear data. Note that a point is required to pass only one of these conditions to be recognized as an edge candidate. Each condition is assigned a unique strength point rating, which is used in the final edge calculation.

TEST 7.3:

$$If there are two consecutive “ Vf ” points in step six , retain “ Vf ” , \\ given 1 “ s ” in the next 5 points . \\ \begin{matrix} & • I & & & & = current Vf & & \\ & • I + 1 & & & & = Vf & & \\ & • I + 5 & & & & = 1 ⨯ S & & \end{matrix} \qquad ( 7.3 )$$

In the fourth test (test 7.4), the system recognizes a falling edge on the strength of the existence of a rising edge on the next segment. This is a powerful way of recognizing a falling edge using one camera that is set to see rising edges only.

TEST 7.4:

$$If the next point is edge space “ s ” , retain “ Vf ” , if there are at \\ least 2 “ Vr ” points within the next three points immediately \\ after the “ s ” point : \\ \begin{matrix} & • I & & & & = current point & & \\ & • I + 1 & & & & = S & & \\ & • I + 2 -> 3 & & & & = Vr & & \end{matrix} \qquad ( 7.4 )$$

In the fifth test (test 7.5), the system recognizes a falling edge given a “V”-shape in the data points. The system looks backwards to verify a manufactured surface (horizontal, “H”), and looks forward for a few falling points, checks for the existence of rising points, and confirms the existence of a manufactured surface following the short rise, hence fulfilling the “V”-shape. This is a powerful way to detect falling edges in the absence of a clear space between the boards.

TEST 7.5: If the current point is horizontal, and the two points before it are also horizontal, retain a falling edge if there are 3 falling edges (vertical or wane) in the first 4 and at least 3 rising edges from the third point to the ninth point.

$$\begin{matrix} & • I & & & & = current H & & & & \\ & • I - 1 -> 2 & & & & = H & & & & \\ & • I + 1 -> 7 & & & & = Vf , Wf , Wfw ( 3 / 4 ) & & & & \\ & • I + 3 -> 12 & & & & = Vr , Wr , Wrw ( 3 / 7 ) & & & & \\ & • I + 6 -> 15 & & & & = H & & & & \end{matrix} \qquad ( 7.5 )$$

Using the sixth test (test 7.6), the system can recognize a falling edge given no falling edge data points and using the strength of the existence of an unclear rising edge obscured by flare. In this case, the system retains a falling edge on the current data point, “H”, if there is space substantiated by evidence of a short rise followed by a prominent manufactured surface “H”. It further verifies that the current point “H” is indeed at the edge of a manufactured surface by searching backwards for more “H” data points, for example 7 “H” data points.

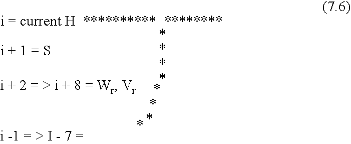

The seventh test (test 7.71) used by the system detects an edge when the falling edge data points exhibit flare. Flare occurs when the data exhibits a curving tail (that does not exist s in real-life) thus introducing error in edge detection. The algorithm confirms the existence of a manufactured edge, “B”, characterizes the flare, confirms a space and a manufactured surface, and retains a “V_{f}”. I is equal to the current H 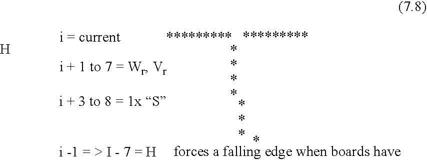
moved both laterally and vertically such that there is neither edge-space nor any falling points. The system recognizes that the fact that there is a rising edge following a manufactured surface implicitly denotes the existence of a falling edge at the end of the first horizontal segment. Note that, the thickness calculations depend on the difference between a falling edge and a rising edge. The moment a falling edge is missed, at least two boards are erroneously considered to be one board resulting in errors.

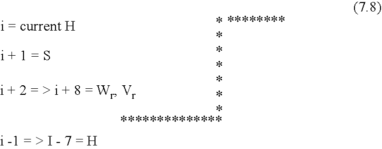

To calculate the thickness of the lumber, the system requires accurate readings of corresponding rising and falling edges. Therefore, the system detects rising edges in a similar manner as described above in relation to falling edges (step 820).

$$\begin{matrix} & • I & & & & = current {X}_{max} & & \end{matrix} \qquad ( 8.1 )$$

Logically, the system retains the first rising edge at a filtered x-minimum point. Most of the available technologies today rely on Xₘₐₓᵢₘᵤₘ to measure thickness or width by subtracting the maximum x-value from the minimum x-value. However, this process does not suffice in detecting inner-board edges.

Since the above Test 8.1 only detects the exterior edge, the system and method according to the invention can detect a rising edge when there are three consecutive “V_{f}” data points following a space “S” (Test 8.2). This is a very strong condition and predecessors of the new algorithm only relied on this condition only for all middle boards. However, in some circumstances, the space “S” is not always there and also at times camera visibility obstructions can create false edges. Therefore, the data processing capability may be inadequate to give accurate readings.

$$\begin{matrix} & • I & & & & = Current Vr , S & & & \\ & • I + 1 -> 3 & & & & = Vr & & & \end{matrix} \qquad ( 8.2 )$$

Thirdly, the system, in Test 8.3 confirms a rising edge when there are two “Vᵣ” data points, substantiated by one space “S” in the preceding four data points.

$$\begin{matrix} & • I & & & & = c urrent Vr & & & \\ & • I + 1 & & & & = Vr & & & \\ & • I - 1 -> 5 & & & & = 1 ⨯ S & & & \end{matrix} \qquad ( 8.3 )$$

In test 8.4, the system further retains a “Vᵣ” when it recognizes a space “S” given that a true “V_{f}” has been located under any one of the falling edge conditions,

$$\begin{matrix} & • I & & & & = current S & & & \\ & • I - 5 & & & & = TRUE Vf ( at least 1 ) & & & \\ & • I + 2 -> 3 & & & & = Vr & & & \end{matrix} \qquad ( 8.4 )$$

Following the above tests, are a series of tests (8.5 to 8.8), which detect riding edges.

In 8.5, the algorithm first looks three data points forward and confirms a horizontal (sawn) surface, then it looks backwards six data points and confirms rising slope. It then searches eight data points backwards starting from the fourth data point to find at least three (3) out of eight falling data points. The test will retain an edge if it confirms three (3) consecutive horizontal points preceding the falling points. This is typical of data configuration as seen by a camera looking down vertically. It sees both edges but fails to present the data in vertical format. Tightly squeezed boards often present this challenge.

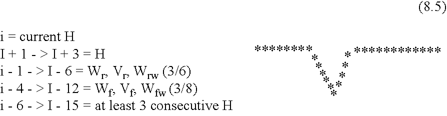

In Test 8.6, the system confirms a horizontal surface as before but does not require falling data points to be present. This is a typical data format for camera set at an angle to see rising edges.

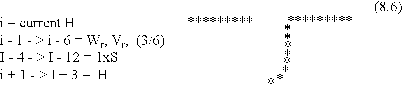

In Test 8.7 below, the system confirms a horizontal space “S” and retains a rising edge on the strength of the existence of a falling edge as defined by Test 7.7 above.

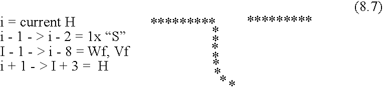

In Test 8.8 below the system superimposes a vertical edge on a falling edge given the horizontal data. This is also referred to as “step recognition”. The thickness of the board to the right is calculated by subtracting the falling edge X-value from the rising edge.

Previously, two boards would erroneously be regarded as one. This algorithm solves this problem by recognising the existance of the rising edge superimposed on the falling edge.

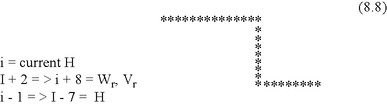

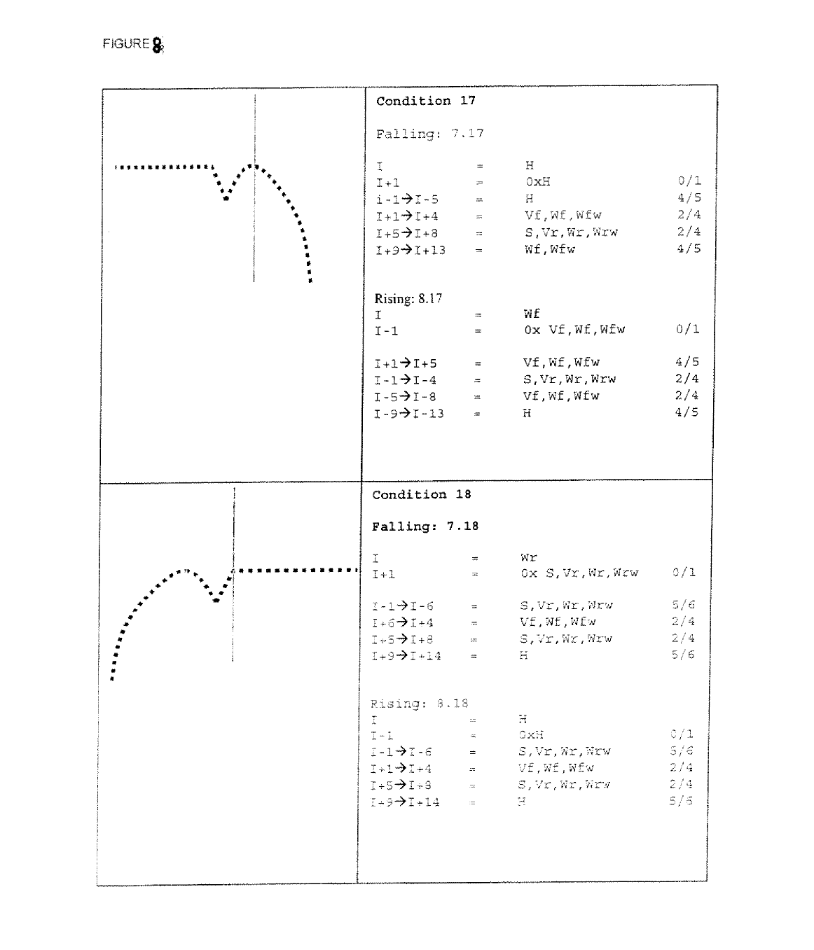

Further examples of tests are shown in FIG. 8 (Tests 7.17 and 7.18). These tests are helpful in detecting edges on rounded profiles. The system can operate these additional tests where rounded profiles exist and can detected edges both falling and rising using these conditions.

An example of pseudo code that can be used to implement the system is listed below:

Step 0: Settings
Set thresholds for the edge recognition algorithm:

| | |
|---|---|
| 1. | Threshold slope for point characterization |

| | | |
|---|---|---|
| a. | Rising Edges | > +75degrees, TAN(75Degrees) |
| b. | Falling Edges | < −75degrees, TAN(−75Degrees) |
| c. | Falling Wane | strong > +29degrees, Tan(29degrees) |
| d. | Rising Wane | > +10degrees, TAN(10Degrees) |
| e. | Falling Wane | strong > +29degrees, Tan(29degrees) |
| f. | Falling Wane | < −10degrees, TAN(−10Degrees) |
| g. | Horizontal | = +−10degrees |

| | |
|---|---|
| 2. | Threshold edge space and filtering |

| | | |
|---|---|---|
| a. | Lower Limit | = 0.060 |
| b. | Filter Limit | = 0.200 |

| | |
|---|---|
| 3. | Threshold group size |

| | |
|---|---|
| a. | 3 for edges |
| b. | 1 for space |
| c. | 15 for group filter |

Step 1a
Record DATA:

| | |
|---|---|
| 1. | Point # |
| 2. | X-values |
| 3. | Y-values |

Step 2
Calculate Xᵢ₊₁ − X ᵢ₊₁
Step 3
Calculate Yⱼ₊₁ − Yⱼ
Step 4

| | |
|---|---|
| a) | Pre-filter |

| | | |
|---|---|---|
| 4.1 | | |
| | I | = current S |
| | S | > 0.200 |
| | i−1->I−15 | < 15 |
| 4.2 | I | = current Xmax |
| | i−1->I−15 | = S > 0.200 |
| 4.3 | I | = current Y |
| | i−1->I−15 | = Yᵢ−Yᵢᵢ > 0.200 |

Divide Filtered Yⱼ₊₁−Yⱼ / abs(Xᵢ₊₁−Xᵢ)
Step 5
Find the angle whose tangent is (Yⱼ₊₁−Yⱼ) / ABS(Xᵢ₊₁−Xᵢ)
Step 6
Program this argument in one string:

| | |
|---|---|
| 1. | IF (X₂−X₁)> space threshold, the point is on the rising side of, space, “S”. |
| 2. | IF (Y₂−Y₁)/(X₂−X₁)< Falling edge threshold, the point is Falling Edge,“Vf” |
| 3. | IF (Y₂−Y₁)/(X₂−X₁)< Falling wane threshold, the point is Falling Edge,“Wf” |
| 4. | IF (Y₂−Y₁)/(X₂−X₁)< Rising wane threshold, the point is Horizontal, “H” |
| 5. | IF (Y₂−Y₁)/(X₂−X₁)< Rising wane threshold, the point is Rising wane, “Wr” |
| 6. | IF (Y₂−Y₁)/(X₂−X₁)< Rising wane threshold, the point is Rising Edge, “Vr” |

Step 7
Retain Filtered Falling Edge Points from step six using the following argument:

| | |
|---|---|
| 1. | If X = X-maximum for all camera data, the point is falling edge, “Vf” |

| | |
|---|---|
| I | = current Xₘₐₓ |

| | |
|---|---|
| 2. | If there are three consecutive “Vf” points in step six, “Vf” |

| | |
|---|---|
| I | = Current Vf |
| I+1->3 | = Vf |
| I+4 | = S,Vf |

| | |
|---|---|
| 3. | If there are two consecutive “Vf” points in step six, retain “Vf”, if there |
| | is 1 “s” in the next 5 points. |

| | |
|---|---|
| I | = current Vf |
| I+1 | = Vf |
| I+5 | = 1xS |

| | |
|---|---|
| 4. | If the next point is edge space “s”, retain “Vf”, if there are at least 2 |
| | “Vr” points within the next three points immediately after the “s” point. |

| | |
|---|---|
| I | = current point |
| I+1 | = S |
| I+2->3 | = Vr |

| | |
|---|---|
| 5. | If there are at least 3 (Vf or Wf points) out of 6 points followed by at |
| | least 3 (Vr or Wr points) out of 6 points just after the Vf/Wf 6-point |
| | range, retain Vf on the last “H” immediately before the (Vf or Wf points. |

| | I | = current H | | |
|---|---|---|---|---|
| | I−1->2 | = H | | |
| | I+1->7 | = Vf,Wf,Wfw (3/4) | | |
| | I+3->12 | = Vr,Wr,Wrw (3/7) | | |
| | I+6->15 | = H | | |
| 7.5 | i i+1 i+2 -> i+8 i−1 -> I−7 | ==== | current H S Wᵣ, VᵣH | 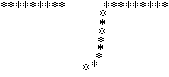 |
| 7.7 | i i+1 -> 7 i+3 -> 8 i−1 -> I−7 | ==== | current H Wᵣ, Vᵣ1x “S”H | 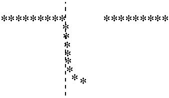 |
| 7.8 | i i+1 i+2 -> i+8 i−1 -> I−7 | ==== | current H S Wᵣ, VᵣH | 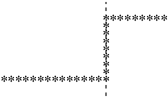 |
| 7.12 | I | = | Vf | |
| | I−1 | = | Vf | |
| | I+1 | = | Vf | |
| 7.13 | I | = | Vf | |
| | I−1 → I−2 | = | Vf | |
| 7.14 | I | = | Vf | |
| | I+1→I+2 | = | Vf | |
| 7.15 | I | = | H | |
| | I −1→I−2 | = | H | 2/2 |
| | I+1→I+4 | = | Wfw,Wf,Vf | 3/3 |
| | I+5→I+6 | = | Wrw,Wr,Vr | 2/2 |
| | I+7→I+9 | = | H | 3/3 |
| 7.16 | I | = | H | |
| | i−1→I−2 | = | H | 2/2 |
| | I+1→I+5 | = | Wfw,Wf,Vf | 4/5 |
| | I+6→I+10 | = | S,Wrw,Wr,Vr | 5/5 |
| | I+11→I+13 | = | H | |
| 7.17 | I | = | H | |
| | i−1→I−2 | = | H | 2/2 |
| | I+1→I+5 | = | Wfw,Wf,Vf | 4/5 |
| | I+6→I+10 | = | Wrw,Wr,Vr | 4/5 |
| | I+11→I+13 | = | H | 3/3 |

Step8
Retain Filtered Rising Edge Points from step six using the following argument:

| | | |
|---|---|---|
| 1. | If Xⱼ | = X-minimum for all camera data, point is rising edge, “Vr” |

| | |
|---|---|
| I | = current Xₘₐₓ |

| | |
|---|---|
| 2. | If there are three consecutive “Vr” points (group) is step six, “Vr” , else, |

| | |
|---|---|
| I | = Current Vr,S |
| I+1->3 | = Vr |

| | |
|---|---|
| 3. | If there are two “Vr” points in step six, retain “Vr”, if there is 1 “s” in |
| | the last 4 points (group+1). |

| | |
|---|---|
| I | = current Vr |
| I+1 | = Vr |
| I−1->5 | = 1xS |

| | |
|---|---|
| 4. | If the CURRENT point is edge space “s”, retain “Vr”, if there is at least 1 |
| | TRUE “Vf” points within 5 points preceding the space. |

| | |
|---|---|
| I | = current S |
| I−5 | = TRUE Vf (at least 1) |
| I+2->3 | = Vr |

| | |
|---|---|
| 5. | If there are at least 3 (Vr or Wr points) out of 6 points preceded by at |
| | least 3 (Vf or Wf points) out of 6 points just before the Vr/Wr 6-point |
| | range, retain Vr on the last (Vr or Wr points) immediately before the H. |

| | | | | |
|---|---|---|---|---|
| | i I+1 -> I+3 i−1 -> I−6 i−4 -> I−12 i−6 -> I−15 | ====== | current H H Wᵣ, Vᵣ, W_{rw} (3/6) W_{f}, V_{f}, W_{fw} (3/8) at least 3consecutive H at least 3consecutive H | 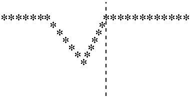 |
| 8.6 | i i−1 to i−6 I−4 -> I−12 i+1 -> I+3 | ==== | current H Wᵣ, Vᵣ (3/6) 1xS H | 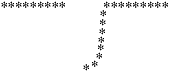 |
| 8.7 | i i−1 to i−2 I−1 to i−8 i+1 -> I+3 | ==== | current H 1x “S”Wf,Vf H | 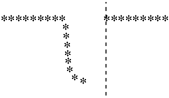 |
| 8.8 | i i+2 -> i+8 i−1 -> I+7 | === | current H Wᵣ, VᵣH | 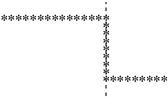 |
| 8.12 | I | = | Vr | |
| | I−1 | = | Vr | |
| | I+1 | = | Vr | |
| 8.13 | I | = | Vr | |
| | I−1 → I−2 | = | Vr | |
| 8.14 | I | = | Vr | |
| | I+1→I+2 | = | Vr | |
| 8.15 | I | = | H | 1/1 |
| | I +1→I+2 | = | H | 2/2 |
| | I−1→I−2 | = | Wrw,Wr,Vr | 2/2 |
| | I−3→I+6 | = | Wfw,Wf, Vf | 3/3 |
| | I−7→I−8 | = | H | 2/2 |
| 8.16 | I | = | H | |
| | I+1→I+2 | = | H | 2/2 |
| | I−1→I−5 | = | S,Wrw,Wr,Vr | 4/5 |
| | I−6→I−10 | = | Wfw,Wf,Vf | 4/5 |
| | I−11→I−13 | = | H | 2/2 |
| 8.17 | I | = | H | |
| | I+1→I+2 | = | H | 2/2 |
| | I−1→I−5 | = | Wrw,Wr,Vr | 4/5 |
| | I−6→I−10 | = | Wfw,Wf,Vf | 4/5 |
| | I−11→I−13 | = | H | 3/3 |

| | |
|---|---|
| 9.1 | Select edges by camera strength |
| 9.2 | Group edges by stringent proximity rules |
| 9.3 | Filter out bad data |
| 9.4 | Calculate sizes |
| 9.5 | Calculate average size |
| 9.6 | Calculate standard deviations |
| 9.7 | Compare with target size and upper and lower control limits |
| 9.8 | Raise alarm when process is out of control |
| 9.9 | Feed data to ERP System, for Enterprise Resource Planning Optimization |
| 10.1 | For double scanner application on horizontal arbors, rotate points by 90 degrees |

After the edges have been determined, the system then calculates their dimensions (step 830), averages (step 840) and standard deviations (step 850). These are compared to predetermined target sizes and upper and lower control limits to determine if the machine center is within limits. If not, an alarm may be raised (step 890). As well, the system determines faces (step 860), steps (step 870 and detects (step 880). This information can be used for real time process control of the machine center (step 900).

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims. Particularly, several of the conditions and tests described herein can be varied without departing from the spirit of the invention.

I claim:

1. A method of measuring a profile of lumber, comprising:
a) obtaining a set of scan data from a piece of lumber;
b) categorizing said data into specified x and y coordinate fields;
c) for each x and y value, subtracting the preceding x or y value from the succeeding x or y value to determine a slope;
d) classifying each of said slopes as one of falling vertical, falling wane strong, falling wane weak, horizontal, rising wane weak, rising wane strong, rising vertical or space based on the value of said slope, and predetermined thresholds.

2. The method of claim 1, further comprising grouping said x and y values into a plurality of groups.

3. The method of claim 2 wherein said system determines if each of said x and y values is a falling or rising edge.

4. The method of claim 3 further comprising.
e) using said data points to correct the performance of a machine center.

5. The method of claim 3 further comprising:
e) using said data points to adjust the performance of a machine center.

6. A system for analyzing lumber at a saw mill, comprising:
a) a machine center for processing a log;
b) a conveyor for moving said log through said machine centre;
c) a nylon strap adjacent to said machine center, said nylon strap removing debris from said lumber leaving said machine center;
d) an air knife positioned adjacent to said machine center, said air knife removing further debris from said lumber leaving said machine center;
e) a laser scanner taking measurements of said lumber leaving said machine center, after said debris has been removed by said nylon straps and said air knife.
